(19) United States
(12) Patent Application Publication
(10) Pub. No.: US 2008/0125336 A1
(43) Pub. Date: May 29, 2008

(54) LUBRICANT FORMULATIONS AND METHODS FOR IMPROVED EXHAUST CATALYST PERFORMANCE

(76) Inventors: John T. Loper, Richmond, VA (US); Gregory H. Guinther, Richmond, VA (US); Roger M. Sheets, Glen Allen, VA (US)

Correspondence Address: LUEDEKA, NEELY & GRAHAM, P.C., P O BOX 1871, KNOXVILLE, TN, 37901, US

(21) Appl. No.: 11/564,620

(22) Filed: Nov. 29, 2006

(51) Int. Cl. C10M 163/00; C07F 9/50

(52) U.S. Cl. 508/364; 508/564

(57) ABSTRACT

A lubricant composition for improved phosphorus retention of a used oil and a method for decreasing catalyst deactivation in a catalytic system for an engine exhaust. The lubricant composition is provided by a base oil and an additive composition that contains a phosphorus-containing additive mixture. The phosphorus-containing additive mixture includes an ash-containing phosphorus compound and an ash-free phosphorus compound. A phosphorus retention value provided by the lubricant composition is greater than about 85 percent after oil aging based on an amount of phosphorus initially present in the lubricant composition.

### TECHNICAL FIELD

The embodiments described herein relate to particular formulations and methods that provide reduced exhaust catalyst deactivation and higher levels of phosphorus in lubricating oil compositions.

### BACKGROUND AND SUMMARY

For over fifty (50) years automotive engine oils have been formulated with zinc dialkyl dithiophosphate (ZDDP) resulting in low levels of wear, oxidation, and corrosion. The additive is truly ubiquitous and found in nearly every modern engine oil. ZDDP imparts multifunctional performance in the areas of anti-wear, anti-oxidation, and anti-corrosion and is undeniably one of the most cost-effective additives in general use by engine oil manufacturers and marketers.

However, there is concern that phosphorus from engine oils may volatilize and pass through the combustion chamber so that elemental phosphorus is deposited on catalytic systems resulting in a loss of catalyst efficiency. ZDDP is known to provide a source of phosphorus that may cause significant problems with exhaust catalytic converters and oxygen sensors when the phosphorus from combusted oil forms an impermeable glaze that may mask precious metal catalytic sites. As a result there is pressure by the automakers to control and/or reduce the amount of ZDDP used in engine oils to facilitate longer converter and oxygen sensor life, and to reduce the manufacturer's initial costs of converters through lower precious metal content.

While a reduction in the phosphorus content of the lubricating oils may improve catalytic converter life or efficiency, the benefits of phosphorus additives for friction control and wear protection may not be conveniently matched by non-phosphorus containing additives. Accordingly, there is a need for additives and methods that enable protection of catalytic activity without significantly reducing a total phosphorus content of the lubricating oil compositions.

In exemplary embodiments there are provided a lubricant composition for improved phosphorus retention and a method for decreasing catalyst deactivation in a catalytic system for an engine exhaust. The lubricant composition is provided by a base oil and an additive composition that contains a phosphorus-containing additive mixture. The phosphorus-containing additive mixture includes an ash-containing phosphorus compound and an ash-free phosphorus compound. A phosphorus retention value provided by the lubricant composition is greater than about 85 percent after oil aging based on an initial phosphorus amount in the lubricant composition.

In another embodiment a lubricant additive composition having a mixture of phosphorus-containing additives is provided. The phosphorus-containing additives may be selected from ash-containing phosphorus compounds and ash-free phosphorus compounds. According to such embodiment, the mixture of phosphorus-containing additives provides a total phosphorus content of from about 500 to about 1000 ppm phosphorus in a lubricant composition. The additive is also effective to provide a phosphorus retention that exceeds about 85 percent after oil aging based on an amount of phosphorus initially present in a lubricant composition.

In another embodiment there is provided a method for increasing a phosphorus retention value in a lubricant composition. The method includes formulating a base oil with an additive having an ash-containing phosphorus compound and an ash-free phosphorus compound therein. The additive provides from about 500 to about 1000 ppm phosphorus in the lubricant composition. Also, a ratio of phosphorus from the ash-containing phosphorus compound to phosphorus from the ash-free phosphorus compound in the lubricant composition is sufficient to provide a phosphorus retention in the lubricant composition that exceeds about 85% after oil aging based on an initial phosphorus amount in the lubricant composition.

Still another embodiment provides a method for decreasing catalyst deactivation in an automotive exhaust catalytic converter. According to the method an engine is lubricated with a lubricant composition having a base oil and a phosphorus additive mixture therein. The additive mixture includes at least one ash-containing phosphorus compound and at least one ash-free phosphorus compound in a ratio of phosphorus from the ash-containing phosphorus compound to phosphorus from the ash-free phosphorus compound ranging from about 3:1 to about 1:3. The phosphorus additive mixture provides from about 500 to about 1000 ppm phosphorus to the lubricant composition.

The compositions and methods described herein are particularly suitable for reducing exhaust catalyst deactivation while maintaining higher levels of phosphorus-containing additives in the lubricant composition. Other features and advantages of the compositions and methods described herein may be evident by reference to the following detailed description which is intended to exemplify aspects of the embodiments without intending to limit the embodiments described herein.

It is to be understood that both the foregoing general description and the following detailed description are exemplary and explanatory only and are intended to provide further explanation of the embodiments disclosed and claimed.

### DETAILED DESCRIPTION OF EXEMPLARY EMBODIMENTS

Lubricant compositions according to embodiments described herein may include a base oil and a phosphorus-containing additive mixture that provides from about 500 to about 1000 ppm phosphorus to the lubricant composition without adversely affecting catalytic activity of an exhaust gas catalyst. The lubricant compositions may be suitable for use in a variety of applications, including but not limited to engine oil applications and/or heavy duty engine oil applications. Examples may include the crankcase and/or the catalytic converter for a variety of applications including spark-ignited and compression-ignited internal combustion engines, automobile and truck engines, marine and railroad diesel engines, and the like.

In addition to the phosphorus-containing additives, the lubricant compositions may include one or more suitable additive components. The additive components may be combined to form an additive package which is combined with a base oil. Alternatively, each of the additive components may be combined directly with the base oil.

### Base Oil

Base oils suitable for use with the exemplary embodiments may be selected from one or more oils of lubricating viscosity such as mineral (or natural) oils, synthetic lubricating oils, vegetable oils, and mixtures thereof. Such base oils include those conventionally employed as crankcase lubricating oils for spark-ignited and compression-ignited internal combustion engines, such as automobile and truck engines, marine and railroad diesel engines, and the like. Suitable base oils may have a NOACK volatility of from about 5 to about 15. As another example, suitable base oils may have a NOACK volatility of from about 10 to about 15. As even further example, suitable base oils may have a NOACK volatility of from about 9 to about 13. Base oils are typically classified as Group I, Group II, Group III, Group IV and Group V, as described in Table 1 below.

TABLE 1
Group I–V Base Oils

| Base Oil | % Sulfur | | % Saturates | Viscosity Index |
|---|---|---|---|---|
| Group I | >0.03 | and/or | <90 | 80–120 |
| Group II | ≦0.03 | and/or | ≧90 | 80–120 |
| Group III | ≦0.03 | and/or | ≧90 | ≧120 |
| Group IV | * | | | |
| Group V | ** | | | |

*Group IV base oils are defined as all polyalphaolefins
**Group V base oils are defined as all other base oils not included in Groups I, II, III and IV and may include gas to liquid base oils.

Non-limiting examples of synthetic base oils include alkyl esters of dicarboxylic acids, polyglycols and alcohols, poly-alpha-olefins, including polybutenes, alkyl benzenes, organic esters of phosphoric acids, polysilicone oils, and alkylene oxide polymers, interpolymers, copolymers and derivatives thereof where the terminal hydroxyl groups have been modified by esterification, etherification, and the like.

Mineral base oils include, but are not limited to, animal oils and vegetable oils (e.g., castor oil, lard oil), liquid petroleum oils and hydrorefined, solvent-treated or acid-treated mineral lubricating oils of the paraffinic, naphthenic and mixed paraffinic-naphthenic types. Oils of lubricating viscosity derived from coal or shale are also useful base oils.

### Phosphorus-Containing Components

The lubricant compositions described herein include a mixture of phosphorus-containing additives. The mixture of phosphorus-containing additives include at least one ash-containing phosphorus compound and at least one ash-free phosphorus compound. The ash-containing phosphorus compound may be selected from a metal dihydrocarbyl dithio-phosphate, for example zinc dialkyldithiophosphate (ZDDP). The ZDDP may have both primary and secondary alkoxy moieties.

Suitable ZDDPs may be prepared from specific amounts of primary and secondary alcohols. For example, the alcohols may be combined in a ratio of from about 100:0 to about 50:50 primary-to-secondary alcohols. As an even further example, the alcohols may be combined in a ratio of about 60:40 primary-to-secondary alcohols. An example of a suitable ZDDP may comprise the reaction product obtained by combining: (i) about 50 to about 100 mol % of about C₁ to about C₁₈ primary alcohol; (ii) up to about 50 mol % of about C₃ to C₁₈ secondary alcohol; (iii) a phosphorus-containing component; and (iv) a zinc-containing component. As a further example, the primary alcohol may be a mixture of from about C₁ to about C₁₈ alcohols. As an even further example, the primary alcohol may be a mixture of a C₄ and a C₈ alcohol. The secondary alcohol may also be a mixture of alcohols. As an example, the secondary alcohol may comprise a C₃ alcohol. The alcohols may contain any of branched, cyclic, or straight chains. The ZDDP may comprise the combination of about 60 mol % primary alcohol and about 40 mol % secondary alcohol. In the alternative, the ZDDP may comprise 100 mol % secondary alcohols, or 100 mol % primary alcohols.

The phosphorus-containing component may comprise any suitable phosphorus-containing component such as, but not limited to a phosphorus sulfide. Suitable phosphorus sulfides may include phosphorus pentasulfide or tetraphosphorus trisulfide.

The zinc-containing component may comprise any suitable zinc-containing component such as, but not limited to zinc oxide, zinc hydroxide, zinc carbonate, zinc propylate, zinc chloride, zinc propionate, or zinc acetate.

The reaction product may comprise a resulting mixture, component, or mixture of components. The reaction product may or may not include unreacted reactants, chemically bonded components, products, or polar bonded components.

The ZDDP or ash-containing phosphorus compound, may be present in an amount sufficient to contribute from about 0.03 wt % to about 0.15 wt % phosphorus in the lubricant composition.

The ash-free phosphorus compound included in the mixture of phosphorus-containing compounds may be selected from an organic ester of phosphoric acid, phosphorous acid, or an amine salt thereof. For example, the ash-free phosphorus-containing compound may include one or more of a dihydrocarbyl phosphite, a trihydrocarbyl phosphite, a monohydrocarbyl phosphate, a dihydrocarbyl phosphate, a trihydrocarbyl phosphate, any sulfur analogs thereof, and any amine salts thereof. As a further example, the ash-free phosphorus-containing compound may include at least one or a mixture of monohydrocarbyl- and dihydrocarbyl phosphate amine salt, for example, an amyl acid phosphate salt may be a mixture of monoamylacid phosphate salt and diamylacid phosphate salt.

A weight ratio based on phosphorus from the ash-containing phosphorus compound and phosphorus from the ash-free phosphorus compound in the lubricating oil composition may range from about 3:1 to about 1:3. Another mixture of phosphorus compounds that may be used may include from about 0.5 to about 2.0 parts by weight of phosphorus from an ash-containing phosphorus compound to about 1 part weight of phosphorus from an ash-free phosphorus compound. Yet another mixture of phosphorus compounds may include about equal parts by weight of phosphorus from the ash-containing phosphorus compound and phosphorus from the ash-free phosphorus compound. Examples of mixtures of phosphorus from the ash-containing and phosphorus from the ash-free phosphorus compounds are provided in the following table.

TABLE 2

| Component | System 1 | System 2 | System 3 | System 4 |
|---|---|---|---|---|
| Phosphorus from ZDDP | 100 wt. % | 75 wt. % | 50 wt. % | 25 wt. % |
| Phosphorus from ash- | 0 wt. % | 25 wt. % | 50 wt. % | 75 wt. % |
| free amine phosphate salt | | | | |

The mixture of phosphorus-containing compounds in the lubricating oil formulation may be present in an amount sufficient to provide from about 500 to about 1000 parts per million by weight of total phosphorus in the lubricating oil formulation. As a further example, the mixture of phosphorus-containing compounds may be present in an amount sufficient to provide from about 600 to about 800 parts per million by weight of total phosphorus in the lubrication oil formulation.

### Optional Components

The lubricant compositions described herein may also contain one or more additional additive components. Suitable additive components may include, but are not limited to dispersants, oxidation inhibitors (i.e., antioxidants), friction modifiers, viscosity modifiers, rust inhibitors, demulsifiers, pour point depressants, antifoamants, and seal swell agents. Each of the foregoing additives, when used, is used at a functionally effective amount to impart the desired properties to the lubricant. Thus, for example, if an additive is a corrosion inhibitor, a functionally effective amount of this corrosion inhibitor would be an amount sufficient to impart the desired corrosion inhibition characteristics to the lubricant. Generally, the concentration of each of these additives, when used, ranges up to about 20% by weight based on the weight of the lubricant composition, and in one embodiment from about 0.001% to about 20% by weight, and in one embodiment about 0.01% to about 10% by weight based on the weight of the lubricant composition.

The additive components described above may be included in the lubricating oil compositions in an amount effective to allow the composition to reliably pass The Afton Catalyst Test. For example, additives may be used in an amount sufficient to obtain a phosphorus retention in the oil of greater than about 85% based on an initial phosphorus amount in the lubricating oil composition after oil aging, wherein the oils are aged according to an Afton Catalyst Test, described below.

As set forth above, the phosphorus-containing compound mixture disclosed herein is used in combination with other additives. The additives are typically blended into the base oil in an amount that enables that additive to provide its desired function. Representative effective amounts of the phosphorus-containing compound mixtures and additives, when used in crankcase lubricants, are listed in Table 3 below. All the values listed are stated as weight percent active ingredient.

TABLE 3

| | Wt. % | Wt. % |
|---|---|---|
| Component | (Broad) | (Typical) |
| Dispersant | 0.5–5.0 | 1.0–2.5 |
| Antioxidant system | 0–5.0 | 0.01–3.0 |
| Metal Detergents | 0.1–15.0 | 0.2–8.0 |
| Corrosion Inhibitor | 0–5.0 | 0–2.0 |
| Metal dihydrocarbyl dithiophosphate | 0.1–6.0 | 0.1–4.0 |
| Ash-free amine phosphate salt | 0.1–6.0 | 0.1–4.0 |
| Antifoaming agent | 0–5.0 | 0.001–0.15 |
| Friction Modifier | 0–5.0 | 0–2.0 |
| Supplemental antiwear agents | 0–1.0 | 0–0.8 |
| Pour point depressant | 0.01–5.0 | 0.01–1.5 |
| Viscosity modifier | 0.01–10.00 | 0.25–7.0 |
| Base oil | balance | balance |
| Total | 100 | 100 |

### EXAMPLES

The following examples are given for the purpose of exemplifying aspects of the embodiments and are not intended to limit the embodiments in any way.

The phosphorus retention (PR) values of the inventive and comparative fluids were determined using an Afton Catalyst Test (hereinafter “ACT”). The ACT is a fired-engine catalyst-aging test developed by Afton Chemical Corporation to assess volatility-related lubricant effects on catalyst deactivation. The ACT uses a 2001MY Ford 4.6 L SOHC V8 engine connected to an eddy-current dynamometer and is operated for 240 hours. Test operating conditions are selected to be consistent with approximately 50,000 km of steady-state highway cruising with the exception of exhaust gas, engine oil, and engine coolant operating temperatures. To minimize the effects of thermally-related catalyst deactivation, the engine exhaust gas temperature is held well below the 750° C. level where this effect is known to occur. To maximize the effects of oil and oil chemistry volatility on catalyst deactivation, engine oil and coolant temperatures are controlled to the highest practical levels, namely, 145° C. and 122° C., respectively. Oil consumption is accurately determined by performing a mass balance on the amount removed versus the amount installed in the engine. The operating conditions of the ACT are listed in Table 4.

TABLE 4
Operating Conditions of Afton Catalyst Test

| | |
|---|---|
| Test Engine: | Ford SOHC 4.6 L V8 operated on |
| | unleaded gasoline |
| Test Fuel: | EEE Emissions-grade gasoline |
| Test Catalyst: | Ford Part Number 3W1Z-5E212-GB |
| Test Duration: | 240 hours |
| Oil Change Interval: | 24 hours |
| Oil Charge: | 4500 grams |
| Engine Speed: | 2000 rpm |
| Oil Temperature: | 145° C. |
| Coolant Temperature: | 122° C. |
| Catalyst Inlet Temperature: | 550° C. |
| Fuel Consumption: | 10.7 kg/hr |

With each oil change during the test, a sample of oil is taken for analytical purposes. The elemental concentration and viscosity properties are determined through the use of an Inductively Coupled Plasma Mass Spectrometer (ICP-MS) and kinematic viscometers. The oil consumption and elemental concentration data provide the amount of oil consumed through volatile means relative to the amount consumed through bulk oil changes. The data also enable the calculation of the amount of phosphorus throughput and percent phosphorus retention.

As the oil ages in an engine, a part of the base stock evaporates or distills, leaving behind the additive elements. The percent of calcium concentration increase is directly proportional to the percent loss of base stock through volatile means. Phosphorus also concentrates in the used oil due to the tendency of certain phosphorus species from the ZDDP to volatilize at elevated temperatures. Phosphorus retention (PR) in the used oil is calculated by multiplying a ratio of the change in calcium concentration (New oil/Used oil) with the ratio of the change in phosphorus concentration (Used oil/New oil) as shown by the equation:

PR=(Ca New oil/Ca Used oil)×(P Used oil/P New oil)×100.

### Calcium is used in the calculation of phosphorus retention to determine the increase in phosphorus concentration due to base oil volatility, since calcium, is not volatile in the lubricant composition.

Catalyst performance may be determined before and after the 240-hour aging process by the performance of a Conversion Efficiency (CE) test. In the CE evaluation the engine is operated at a steady-state condition while the exhaust gas temperature is controlled to maintain a steady catalyst inlet temperature. Exhaust inlet temperature is stepped up in 15° C. intervals from 200° C. to 440° C. while hydrocarbon (HC), carbon monoxide (CO), and oxides of nitrogen (NOx) emissions are measured through probes inserted before and after the catalyst. Curves can be constructed from the data to provide the “T50” value or temperature where 50% conversion occurs for each emission type. By comparing the T50 values before and after aging the relative amount of catalyst degradation can be determined and compared to aged oils. The 240 hour oil aging process typically results in an increase in all of the T50 values.

A lubricant formulation (Sample 1) containing a conventional ash-containing phosphorus additive (System 1, Table 2) and a lubricant formulation (Sample 2) containing a mixture of ash-containing and ash-free phosphorus additives (System 3, Table 2) were tested in the Afton Catalyst Test using Group II+ base oils. The comparative formulation (Sample 1) included a typical ZDDP additive. The inventive formulation (Sample 2) included a mixture of ZDDP and an amine salt of an acid phosphate. Table 5 shows the results of the testing.

Oil consumption is indicated in grams/hour and maintaining a lower value is desirable for engine and catalyst durability. The amount of catalyst deactivation was measured by the increase in T50 temperature and maintaining a lower T50 temperature leads to overall lower emissions.

TABLE 5

| | Sample 1 | Sample 2 |
|---|---|---|
| Phosphorus system (Table 2) | System 1 | System 3 |
| Phosphorus, (initial wt. %) | 1009 | 1049 |
| Calcium, (initial wt. %) | 2139 | 1859 |
| Zinc, (initial wt. %) | 1159 | 626 |
| Phosphorus Retention (PR), (wt. %) | 81.6 | 90.5 |
| Oil consumption (grams/hr) | 33 | 29 |
| HC T50 increase, ° C. | 35 | 18 |
| CO T50 increase, ° C. | 66 | 26 |
| NOₓ T50 increase, ° C. | 60 | 22 |

As shown in the results given in Table 5, the inventive formulation (Sample 2) retained more phosphorus in the used oil, gave less catalyst deactivation, and produced lower oil consumption than the comparative formulation (Sample 1). Sample 2, compared to a conventionally-formulated engine oil (Sample 1), exhibited lower volatile phosphorus throughput, higher PR, and less increase in T50 for all three emissions, HC, CO and NOₓ. All of these benefits occurred with a total phosphorus level that is approximately equal to the total phosphorus level in Sample 1. Accordingly, the results indicated that a lubricant formulation may include an increased phosphorus level without adversely affecting catalyst performance.

At numerous places throughout this specification, reference has been made to a number of U.S. Patents and publications. All such cited documents are expressly incorporated in full into this disclosure as if fully set forth herein.

The foregoing embodiments are susceptible to considerable variation in its practice. Accordingly, the embodiments are not intended to be limited to the specific exemplifications set forth hereinabove. Rather, the foregoing embodiments are within the spirit and scope of the appended claims, including the equivalents thereof available as a matter of law.

The patentees do not intend to dedicate any disclosed embodiments to the public, and to the extent any disclosed modifications or alterations may not literally fall within the scope of the claims, they are considered to be part hereof under the doctrine of equivalents.

What is claimed is:

1. A lubricant composition comprising:
(a) a base oil; and
(b) an additive composition comprising a phosphorus-containing additive mixture including an ash-containing phosphorus compound and an ash-free phosphorus compound,
wherein a phosphorus retention value of the lubricant composition is greater than about 85% after oil aging based on an initial phosphorus amount in the lubricant composition.

2. The lubricant composition of claim 1, wherein the lubricant composition is an engine oil.

3. The lubricant composition of claim 1, wherein the lubricant composition is a heavy duty engine oil.

4. The lubricant composition of claim 1, wherein the base oil has a NOACK volatility of from about 5 to about 15.

5. The lubricant composition of claim 4, wherein the base oil has a NOACK volatility of from about 9 to about 13.

6. The lubricant composition of claim 1, wherein the base oil comprises a mineral oil, a synthetic oil, or a mixture thereof.

7. The lubricant composition of claim 1, wherein the base oil comprises on or more of a member selected from the group consisting of: a group I base oil, a group II base oil, a group III base oil, a group IV base oil, and a group V base oil.

8. The lubricant composition of claim 1, wherein the total amount of phosphorus in the lubricant composition comprises from about 500 to about 1000 ppm.

9. The lubricant composition of claim 1, wherein a ratio of phosphorus from the ash containing phosphorus compound to phosphorus from the ash free phosphorus compound in the phosphorus-containing additive mixture ranges from about 3:1 to about 1:3.

10. The lubricant composition of claim 1, wherein the ash-containing phosphorus compound comprises a metal dihydrocarbyl dithiophosphate.

11. The lubricant composition of claim 1, wherein the ash-free phosphorus compound comprises a metal-free amine salt of an acid phosphate.

12. A lubricant additive composition comprising a mixture of phosphorus-containing additives selected from the group consisting of ash-containing phosphorus compounds and ash-free phosphorus compounds, wherein the mixture of phosphorus-containing additives provides a total phosphorus content of from about 500 to about 1000 ppm phosphorus in a lubricant composition, and wherein the additive composition is effective to provide a phosphorus retention that exceeds about 85 percent after oil aging based on an amount of phosphorus initially present in a lubricant composition.

13. The additive composition of claim 12, wherein the mixture of phosphorus-containing additives has a ratio of phosphorus from the ash-containing phosphorus compounds to phosphorus from the ash-free phosphorus compounds ranging from about 3:1 to about 1:3.

14. The additive composition of claim 12, wherein the ash-containing phosphorus compound comprises a metal dihydrocarbyl dithiophosphate.

15. The additive composition of claim 12, wherein the ash-free phosphorus compound comprises a metal-free amine salt of an acid phosphate.

16. An engine oil lubricant comprising the additive composition of claim 12.

17. A method for increasing a phosphorus retention value in a lubricant composition comprising formulating a base oil with an additive comprising an ash-containing phosphorus compound and an ash-free phosphorus compound to provide from about 500 to about 1000 ppm phosphorus in the lubricant composition, wherein a ratio of phosphorus from the ash-containing phosphorus compound to phosphorus from the ash-free phosphorus compound in the lubricant composition is sufficient to provide a phosphorus retention in the lubricant composition that exceeds about 85 percent after oil aging based on an initial phosphorus amount in the lubricant composition.

18. The method of claim 17, wherein the base oil has a NOACK volatility of from about 5 to about 15.

19. The method of claim 17, wherein the ratio of phosphorus from the ash containing phosphorus compound to phosphorus from the ash free phosphorus compound in the lubricant composition ranges from about 3:1 to about 1:3.

20. The method of claim 17, wherein the ash-containing phosphorus compound comprises a metal dihydrocarbyl dithiophosphate.

21. The method of claim 17, wherein the ash-free phosphorus compound comprises a metal-free amine salt of an acid phosphate.

22. A method for decreasing catalyst deactivation in an automotive exhaust catalytic converter, comprising lubricating an engine with a lubricant composition comprising:
(a) a base oil; and
(b) a phosphorus additive mixture comprising at least one ash-containing phosphorus compound and at least one ash-free phosphorus compound in a ratio of phosphorus from the ash-containing phosphorus compound to phosphorus from the ash-free phosphorus compound ranging from about 3:1 to about 1:3, wherein the phosphorus additive mixture provides from about 500 to about 1000 ppm phosphorus to the lubricant composition.

23. The method of claim 22, wherein the base oil has a NOACK volatility of from about 5 to about 15.

24. The method of claim 22, wherein the ash-containing phosphorus compound comprises a metal dihydrocarbyl dithiophosphate.

25. The method of claim 22, wherein the ash-free phosphorus compound comprises a metal-free amine salt of an acid phosphate.
